(19) United States
(12) Patent Application Publication
(10) Pub. No.: US 2025/0077372 A1
(43) Pub. Date: Mar. 6, 2025

(54) PROACTIVE INSIGHTS FOR SYSTEM HEALTH

(71) Applicant: Dell Products L.P., Hopkinton, MA (US)

(72) Inventors: Lisa O'Mahony, Glanmire (IE); Francisco Jaen, Cork (IE)

(73) Assignee: Dell Products L.P., Hopkinton, MA (US)

(21) Appl. No.: 18/461,543

(22) Filed: Sep. 6, 2023

(51) Int. Cl. G06F 11/22

(52) U.S. Cl. CPC G06F 11/2257

(57) ABSTRACT

Current data from a SaaS system and associated remote data storage system is used to automate proactive fault avoidance. Machine learning models are used to predict faults. Rules are used with a rules engine to calculate corresponding fault avoidance recommendations. The model and rules are trained and created using source data from the SaaS system and remote data storage system with which the model and rules will be used. Current data from those systems is used to predict future faults and calculate recommendations to avoid the predicted faults. Implementation of a recommendation triggers a re-test to determine whether the predicted fault is still likely to occur.

### TECHNICAL FIELD

The subject matter of this disclosure is generally related to management of remote data storage by computing systems such as software as a service (SaaS) systems.

### BACKGROUND

Problems that occur on remote data storage used by a SaaS system are currently detected and resolved manually. Problem detection and resolution are time-consuming and costly processes because experienced engineers are required to identify root causes and select suitable resolutions. The processes are also reactive, which is problematic because SaaS system performance may be sub-optimal for the potentially significant period of time between occurrence and resolution of a problem.

### SUMMARY

A method in accordance with some implementations comprises: modelling faults using source data from a computing system and an associated remote data storage system that is used by the computing system; and generating fault predictions based on current data from the remote data storage system and the modelled faults.

An apparatus in accordance with some implementations comprises: a computing system that runs instances of computer software; a remote data storage system that maintains data used by the instances of computer software; and a fault prediction system configured to: generate a model of faults using source data from the computing system and the remote data storage system; and generate fault predictions using current data from the remote data storage system and the model.

A non-transitory computer-readable storage medium in accordance with some implementations has instructions that when executed by a computer perform a method comprising: modelling faults using source data from a computing system and an associated remote data storage system that is used by the computing system; and generating fault predictions based on current data from the remote data storage system and the modelled faults.

The summary does not limit the scope of the claims or the disclosure. All examples, embodiments, aspects, implementations, and features can be combined in any technically possible way and the method and process steps may be performed in any order.

### BRIEF DESCRIPTION OF THE FIGURES

FIG. 1 illustrates a fault prediction system that provides fault predictions and fault avoidance recommendations to a SaaS system and remote data storage system.

FIG. 2 illustrates steps performed by the fault prediction system.

FIG. 3 illustrates fault avoidance recommendation processing.

FIG. 4 illustrates an example of a remote data storage node.

FIG. 5 illustrates a specific example of a predicted storage capacity exhaustion fault.

### DETAILED DESCRIPTION

The terminology used in this disclosure is intended to be interpreted broadly within the limits of subject matter eligibility. The terms “disk,” “drive,” and “disk drive” are used interchangeably to refer to non-volatile storage media and are not intended to refer to any specific type of non-volatile storage media. The terms “logical” and “virtual” are used to refer to features that are abstractions of other features, e.g., and without limitation abstractions of tangible features. The term “physical” is used to refer to tangible features that possibly include, but are not limited to, electronic hardware. For example, multiple virtual computers could operate simultaneously on one physical computer. The term “logic” is used to refer to special purpose physical circuit elements, firmware, software, computer instructions that are stored on a non-transitory computer-readable medium and implemented by multi-purpose tangible processors, and any combinations thereof. Aspects of the inventive concepts are described as being implemented in a data storage system that includes host servers and a storage array. Such implementations should not be viewed as limiting. Those of ordinary skill in the art will recognize that there are a wide variety of implementations of inventive concepts in view of the teachings of the present disclosure.

Some aspects, features, and implementations described herein may include machines such as computers, electronic components, optical components, and processes such as computer-implemented procedures and steps. It will be apparent to those of ordinary skill in the art that the computer-implemented procedures and steps may be stored as computer-executable instructions on a non-transitory computer-readable medium. Furthermore, it will be understood by those of ordinary skill in the art that the computer-executable instructions may be executed on a variety of tangible processor devices, i.e., physical hardware. For practical reasons, not every step, device, and component that may be part of a computer or data storage system is described herein. Those of ordinary skill in the art will recognize such steps, devices, and components in view of the teachings of the present disclosure and the knowledge generally available to those of ordinary skill in the art. The corresponding machines and processes are therefore enabled and within the scope of the disclosure.

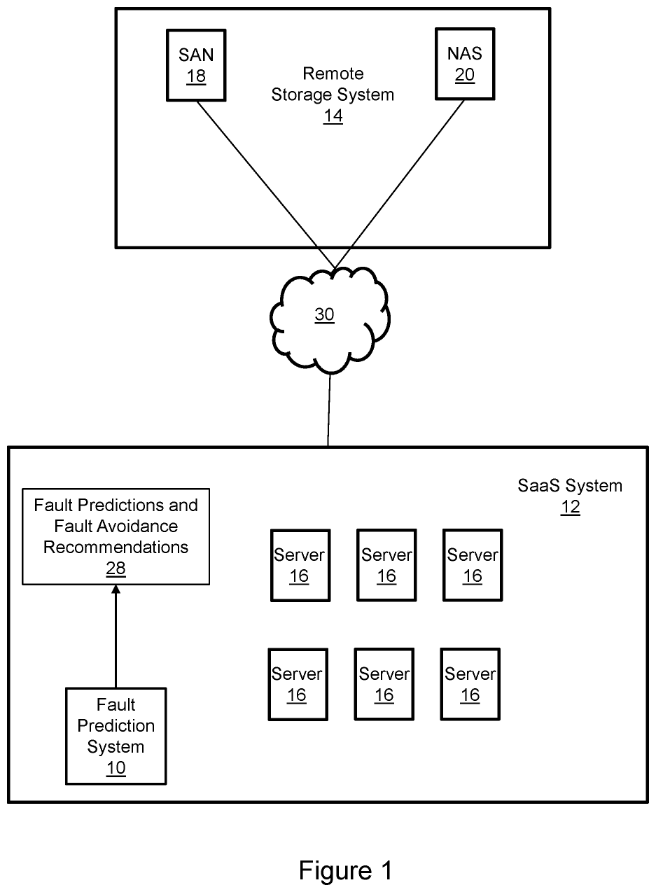

FIG. 1 illustrates a fault prediction system 10 that generates fault predictions and fault avoidance recommendations 28 within a SaaS system 12 to facilitate management of an associated remote data storage system 14. Although the fault prediction system may include computer software running on a server computer, it could also be implemented by, or distributed on, compute nodes in one or both of the SaaS system and the remote data storage system. The SaaS system includes server computers 16 that run instances of software programs, usage of which is provided as a service by a first organization to other organizations or individuals. The data used by the software programs is maintained by the remote data storage system 14, which may be independently operated by a second organization, so integration, control, and management of the overall system may be non-unified. The remote data storage system 14 includes data storage nodes such as network-attached storage nodes 20 and storage area network nodes 18. The fault prediction system 10 uses one or more of, in any combination, artificial intelligence/machine learning (AI/ML), analytical algorithms, telemetry data, and performance data to predict future faults and generate recommendations for avoiding the predicted faults. The SaaS system provides a lifecycle management loop where it orchestrates and maintains the lifecycle of the faults and recommendations.

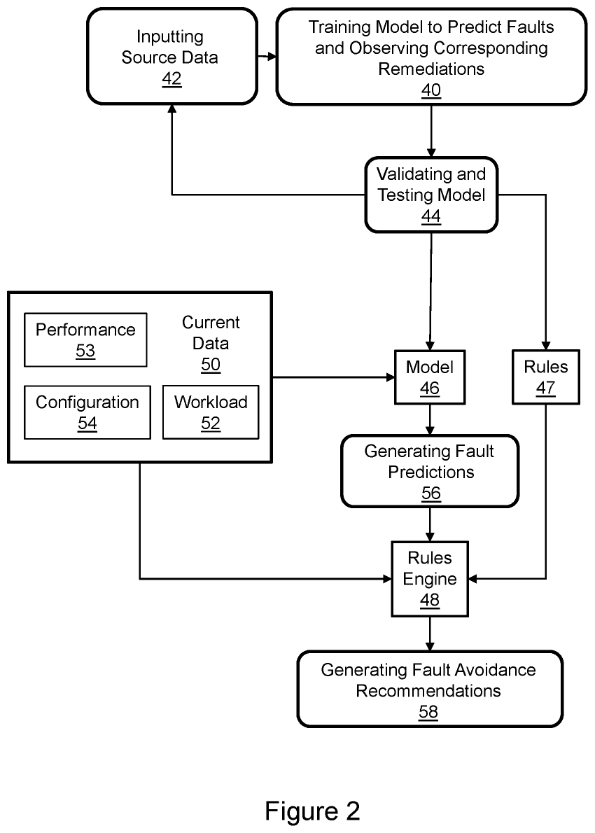

FIG. 2 illustrates steps performed by the fault prediction system. Step 40 is training an AI/ML model to recognize relationships between fault conditions and features in source data from the SaaS system and remote data storage system with which the fault prediction system will be used. The source data may include, but is not limited to, analytics, telemetry and performance data including past SaaS system performance, SaaS system configuration, SaaS system workload, remote data storage system performance, remote data storage system configuration, and remote data storage system workload. The source data is timestamped, and performance, workload and configuration metrics are used as features for training the model to recognize combinations of features associated with different types of faults. The term “faults” is used broadly to refer to any aspect of the system that would normally be manually remediated, e.g., mismatched configurations, resource exhaustion, and actual subsystem failures, for example, and without limitation. The source data includes indications of remediations that were manually selected and implemented. For example, system reconfiguration and addition of computing, memory, and storage resources are each indicated such that the effects on the SaaS system and remote data storage system metrics are observable and can be correlated with other features. Step 44 is testing and validating the model. If the model does not pass the test and validation requirements, then step 42 is inputting additional source data that is used to update the model in step 40. Steps 40, 44, and 42 are iterated until the model passes the test and validation requirements. When the model passes the test and validation requirements, a usable model 46 and rules 47 are generated. The model indicates faults associated with combinations of analytics data values. The rules indicate remediations that were used to correct historical faults with various combinations of source data values. Those remediations are used to select fault avoidance recommendations.

Current data 50, including telemetry, analytics and performance data including SaaS and remote storage system performance data 53, SaaS and remote storage system configuration data 54, and SaaS and remote storage system workload data 52, are used with the model 46 on an ongoing basis for generating fault predictions as indicated in step 56. For example, analytics data values or trends in the analytics data values that indicate a likelihood of future occurrence of a specific fault according to the model 46 prompt generation of a fault prediction. The fault prediction triggers use of the rules engine 48 for generating corresponding fault avoidance recommendations as indicated in step 58. The fault prediction indicates the type of fault, e.g., excessive input-output (IO) latency. The rules engine uses the type of fault in the fault prediction, rules 47, and analytics data 50 to generate a fault avoidance recommendation. Rules 47 may indicate multiple previously observed remediations for a given type of fault. Analytics data 50 is used by the rules engine 48 with the rules 47 to calculate which of the previously observed remediations is most likely to be successful based on similarity of current data values with the source data values associated with the previously observed remediations. For example, observed root causes of excessive IO latency might include both over-utilization of the storage resources of the remote data storage system and over-utilization of the computing resources of the remote data storage system, so the current data is used to calculate which root cause is most likely associated with the current predicted fault because, for example, adding compute resources would not cure exhaustion of storage resources. Thus, the fault prediction system predicts future faults based on similarity with previously observed faults and uses previous remediations to recommend actions to avoid the predicted future faults before those faults occur so that remediation actions may be implemented in time to avoid occurrence of the predicted faults.

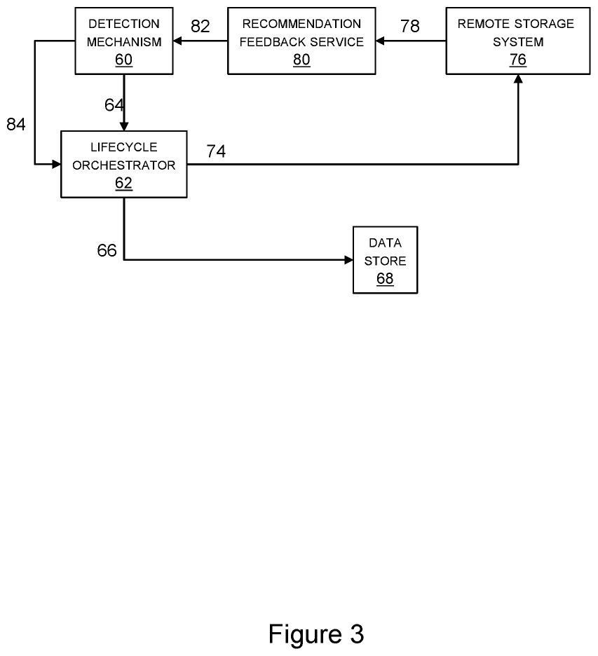

FIG. 3 illustrates fault avoidance recommendation processing in greater detail. Detection mechanism 60, which includes the model, rules, and rules engine, predicts a future fault, calculates an associated fault avoidance recommendation, and signals 64 both the fault type and the fault avoidance recommendation to a lifecycle orchestrator 62. In response, the lifecycle orchestrator 62 signals 66 updated lifecycle state to a data store 68. The updated lifecycle state indicates the predicted future fault type and associated fault avoidance recommendation. The lifecycle orchestrator 62 also signals 74 the predicted future fault and associated fault avoidance recommendation with state to the remote data storage system 76. Personnel who manage the SaaS system or remote data storage system decide whether to implement the fault avoidance recommendation, which may include signaling between the systems. If the fault avoidance recommendation is implemented, i.e., becomes a fault remediation, then recommendation applied (remediation) feedback 78 is sent to a recommendation feedback service 80, which generates and sends a trigger 82 to the detection mechanism to prompt the rules to be re-evaluated based on updated current data to determine whether the predicted fault has been resolved by the fault remediation. If the detection mechanism determines that the predicted fault has been resolved, then fault resolution is signaled 84 to the lifecycle orchestrator 62.

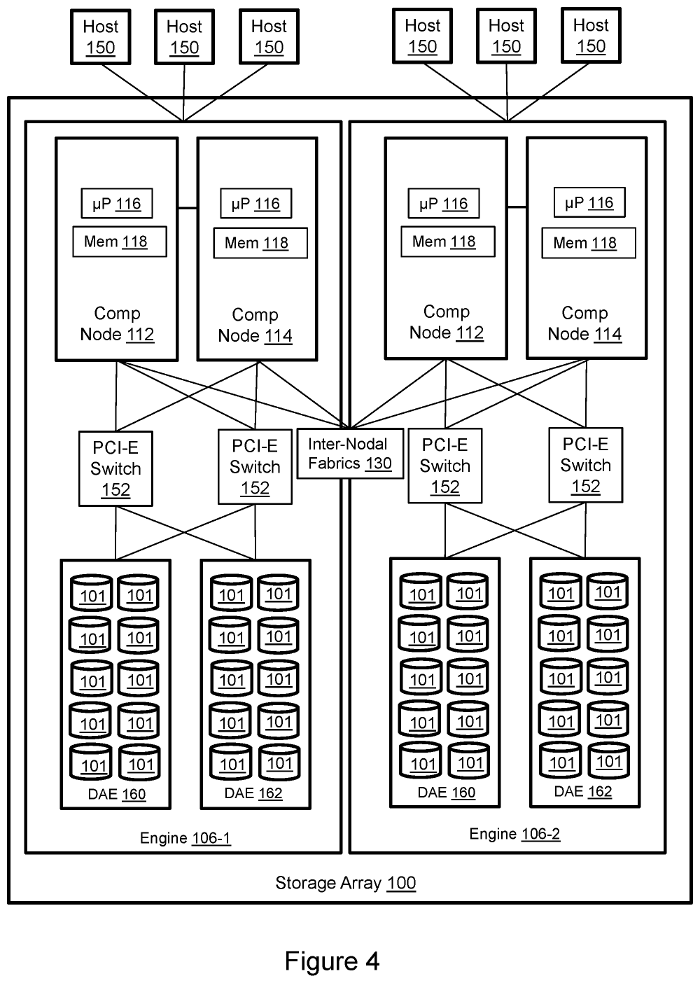

FIG. 4 illustrates an example of a remote data storage node. A storage array 100 is shown with two engines 106-1, 106-2, but might include any number of engines. Each engine includes disk array enclosures (DAEs) 160, 162 and a pair of peripheral component interconnect express (PCI-e) interconnected compute nodes 112, 114 (aka storage directors) in a failover relationship. Within each engine, the compute nodes and DAEs are interconnected via redundant PCI-E switches 152. Each DAE includes managed drives 101 that are non-volatile storage media that may be of any type, e.g., solid-state drives (SSDs) based on nonvolatile memory express (NVMe) and EEPROM technology such as NAND and NOR flash memory. Each compute node is implemented as a separate printed circuit board and includes resources such as at least one multi-core processor 116 and local memory 118. The processor 116 may include central processing units (CPUs), graphics processing units (GPUs), or both. The local memory 118 may include volatile media such as dynamic random-access memory (DRAM), non-volatile memory (NVM) such as storage class memory (SCM), or both. Each compute node allocates a portion of its local memory 118 to a shared memory that can be accessed by all compute nodes of the storage array. Each compute node includes one or more adapters and ports for communicating with SaaS system servers for servicing IOs. Each compute node also includes one or more adapters for communicating with other compute nodes via redundant inter-nodal channel-based InfiniBand fabrics 130.

Data that is created and used by instances of the applications running on the SaaS system servers is maintained on the managed drives 101. The managed drives are not discoverable by the SaaS system servers, so the storage array creates logical production storage objects that can be discovered and accessed by those servers. Without limitation, a production storage object may be referred to as a source device, production device, production volume, or production LUN, where the logical unit number (LUN) is a number used to identify logical storage volumes in accordance with the small computer system interface (SCSI) protocol. From the perspective of the SaaS system servers, each production storage object is a single disk drive having a set of contiguous fixed-size logical block addresses (LBAs) on which data used by the instances of one of the host applications resides. However, the SaaS application data is stored at non-contiguous addresses on various managed drives 101.

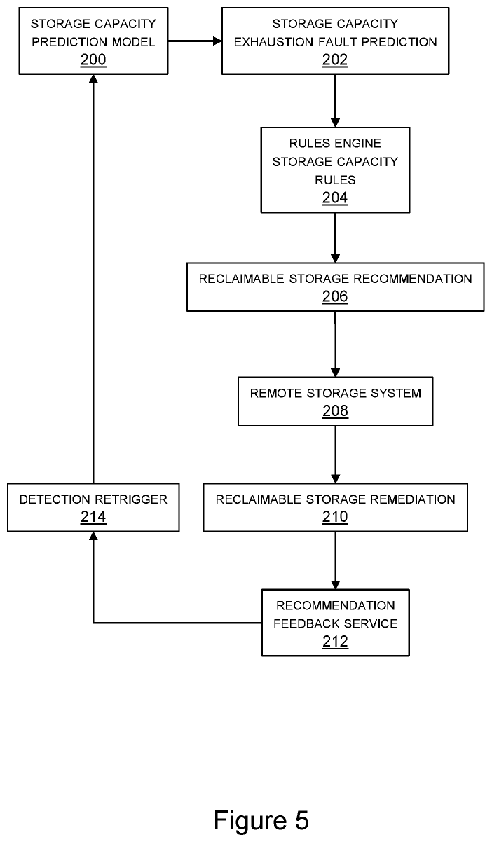

FIG. 5 illustrates a specific example of a predicted storage capacity exhaustion fault. A data storage capacity prediction model 200 predicts a fault 202 that storage capacity of the remote data storage system available to the SaaS system will be exhausted in one month due to increasing data storage. The storage capacity rules 204 are used by the rules engine to calculate that a reclaimable storage fault avoidance recommendation 206 is suitable based on current data. For example, the current data may indicate that storage space is being utilized to maintain more snapshots than are needed. The reclaimable storage recommendation 206 is sent to the remote data storage system 210. The recommendation is implemented, e.g., by deleting gaining snapshots, and a reclaimable storage remediation message 210 is generated by the remote data storage system to indicate that the recommendation has been implemented. In response, the recommendation feedback service 212 signals a detection retrigger 214 to cause the model and/or rules to be used to re-evaluate based on updated current data to determine whether the predicted fault was avoided by the remediation.

Specific examples have been presented to provide context and convey inventive concepts. The specific examples are not to be considered as limiting. A wide variety of modifications may be made without departing from the scope of the inventive concepts described herein. Moreover, the features, aspects, and implementations described herein may be combined in any technically possible way. Accordingly, modifications and combinations are within the scope of the following claims.

1. A method comprising:
prior to generating fault predictions, modelling faults using source data from a computing system comprising server computers running instances of a software program and an associated remote data storage system that is used by the computing system to store data associated with the software program; and
generating fault predictions based on current data from the remote data storage system and the modelled faults.

2. The method of claim 1 further comprising generating rules for selecting fault avoidance recommendations based on the source data.

3. The method of claim 2 further comprising using the rules with the current data to select fault avoidance recommendations corresponding to predicted faults.

4. The method of claim 3 further comprising proactively implementing at least some of the fault avoidance recommendations.

5. The method of claim 4 further comprising generating messages indicating that specific fault avoidance recommendations have been implemented.

6. The method of claim 5 further comprising using the modelled faults and current data from the computing system and the associated remote data storage system to calculate efficacy of implementation of the fault avoidance recommendations to avoid predicted faults.

7. The method of claim 6 further comprising including performance, workload, and configuration data in the source data and the current data.

8. An apparatus comprising:
a computing system comprising server computers that run instances of a computer software program;
a remote data storage system that maintains data used by the instances of the computer software program; and
a fault prediction system configured to:
generate a model of faults using source data from the computing system and the remote data storage system prior to generating fault predictions; and
generate fault predictions using current data from the remote data storage system and the model.

9. The apparatus of claim 8 further comprising the fault prediction system being configured to generate rules for selecting fault avoidance recommendations based on the source data.

10. The apparatus of claim 9 further comprising the fault prediction system being configured to use the rules with the current data to select fault avoidance recommendations corresponding to predicted faults.

11. The apparatus of claim 10 further comprising the fault prediction system being configured to proactively implement at least some of the fault avoidance recommendations.

12. The apparatus of claim 11 further comprising the fault prediction system being configured to receive messages indicating that specific fault avoidance recommendations have been implemented.

13. The apparatus of claim 12 further comprising the fault prediction system being configured to use the model and current data from the computing system and the remote data storage system to calculate efficacy of implementation of the fault avoidance recommendations to avoid predicted faults.

14. The apparatus of claim 13 in which the source data and the current data comprise performance, workload, and configuration data.

15. A non-transitory computer-readable storage medium with instructions that when executed by a computer perform a method comprising:
prior to generating fault predictions, modelling faults using source data from a computing system comprising server computers running a software program and an associated remote data storage system that is used by the computing system to store data associated with the software program; and
generating fault predictions based on current data from the remote data storage system and the modelled faults.

16. The non-transitory computer-readable storage medium of claim 15 in which the method further comprises generating rules for selecting fault avoidance recommendations based on the source data.

17. The non-transitory computer-readable storage medium of claim 16 in which the method further comprises using the rules with the current data to select fault avoidance recommendations corresponding to predicted faults.

18. The non-transitory computer-readable storage medium of claim 17 in which the method further comprises proactively implementing at least some of the fault avoidance recommendations.

19. The non-transitory computer-readable storage medium of claim 18 in which the method further comprises generating messages indicating that specific fault avoidance recommendations have been implemented.

20. The non-transitory computer-readable storage medium of claim 19 in which the method further comprises using the modelled faults and current data from the computing system and the associated remote data storage system to calculate efficacy of implementation of the fault avoidance recommendations to avoid predicted faults.
